(19) United States
(12) Patent Application Publication
(10) Pub. No.: US 2015/0128129 A1
(43) Pub. Date: May 7, 2015

(54) METHOD AND DEVICE FOR INSTALLING APPLICATION

(71) Applicant: Xiaomi Inc., Beijing (CN)

(72) Inventors: Liang Yang, Beijing (CN); Wenlin Wang, Beijing (CN); Xingping Zheng, Beijing (CN)

(21) Appl. No.: 14/471,558

(22) Filed: Aug. 28, 2014

Related U.S. Application Data
(63) Continuation of application No. PCT/CN2014/077399, filed on May 13, 2014.

(30) Foreign Application Priority Data
Nov. 1, 2013 (CN) 201310535264.2

(51) Int. Cl. G06F 9/445; H04L 29/08

(52) U.S. Cl. CPC G06F 8/61; H04L 67/10
USPC 717/178

(57) ABSTRACT

A method for installing an application on a device, includes: when determining that a current processing request is an installation request of a downloaded application, determining an installation program object carried by an operating system itself as a process program object in response to the installation request; and starting up the installation program object carried by the operating system itself to install the downloaded application corresponding to the installation request.

### CROSS REFERENCE TO RELATED APPLICATIONS

This application is a Continuation of International Application No. PCT/CN2014/077399, filed May 13, 2014, which claims priority of Chinese Patent Application No. 201310535264.2, filed Nov. 1, 2013, the entire contents of all of which are incorporated herein by reference.

### TECHNICAL FIELD

The disclosure generally relates to the field of computer technology, and more particularly, to a method and a device for installing an application.

### BACKGROUND

As a core of a smart phone, an operating system has become a competitive part of the smart phone. The operating system makes a smart phone increasingly become a microcomputer. A user may install applications provided by third-party service providers, such as games, on the smart phone, so as to increase functions of the smart phone.

In order to better share information, software development tools are offered that allow anyone to develop applications based on a certain operating system. This brings convenience to users and meets the users' diverse demands for applications, but may also lead to viruses, trojans, and other malicious applications developed using those tools on the operating system.

Deceptive attacks of malicious applications constantly emerge with new forms, which may be hard to detect and eliminate. One deceptive means of attack is, by making use of the users' behaviors that the users of smart phones often directly download applications for installations via routes such as Internet, to intercept the users' installation operation and then give misleading prompts that guide the users to install applications recommended by malicious applications, or directly install the applications that the malicious applications want to install, or prevent the users from installing certain applications (such as security applications).

The deceptive attack is difficult to be identified by the users due to their hidden characteristics. Meanwhile, because the deceptive attack controls the installation of applications, it may cause a significant harm. One conventional approach against such attack is that, when a user chooses to install an application that has been downloaded on a smart phone, the operating system displays a selection dialog box, to prompt the user to select an application in this dialog box so as to install the application. However, because a malicious application is often renamed to pretend as a security application, ordinary users who have no experience or do not carefully distinguish are vulnerable to be cheated by the malicious application and easy to choose the malicious application, thereby being attacked and harmed by the malicious application.

### SUMMARY

According to a first aspect of the present disclosure, there is provided a method for installing an application on a device, comprising: when determining that a current processing request is an installation request of a downloaded application, determining an installation program object carried by an operating system itself as a process program object in response to the installation request; and starting up the installation program object carried by the operating system itself to install the downloaded application corresponding to the installation request.

According to a second aspect of the present disclosure, there is provided a device for installing an application, comprising: a processor; and a memory for storing instructions executable by the processor; wherein the processor is configured to: when determining that a current processing request is an installation request of a downloaded application, determine an installation program object carried by an operating system itself as a process program object in response to the installation request; and start up the installation program object carried by the operating system itself to install the downloaded application corresponding to the installation request.

According to a third aspect of the present disclosure, there is provided a non-transitory storage medium having stored therein instructions that, when executed by a processor of a device, cause the device to perform a method for installing an application, the method comprising: when determining that a current processing request is an installation request of a downloaded application, determining an installation program object carried by an operating system itself as a process program object in response to the installation request; and starting up the installation program object carried by the operating system itself to install the downloaded application corresponding to the installation request.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flowchart of a method for installing an application, according to an exemplary embodiment.

FIG. 2 is a flowchart of a method for installing an application, according to an exemplary embodiment.

FIG. 3 is a flowchart of a method for installing an application, according to an exemplary embodiment.

FIG. 4 is a block diagram of a device for installing an application, according to an exemplary embodiment.

FIG. 5 is a block diagram of an object determining module, according to an exemplary embodiment.

FIG. 6 is a block diagram of an object determining module, according to an exemplary embodiment.

FIG. 7 is a diagram of a device for installing an application, according to an exemplary embodiment.

### DESCRIPTION OF THE EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

In exemplary embodiments, there are provided methods for installing an application. For example, when determining that a current processing request is an installation request of a downloaded application, the installation request is directly directed to an installation program object carried by an operating system itself. Also for example, registration of other third-party process program objects is ignored in the process list, and the installation program object carried by the operating system itself is mandatorily selected to directly install an application corresponding to the application installation request. As a result, malicious applications have no opportunity to participate in the process of application installation, thus improving security of the operating system.

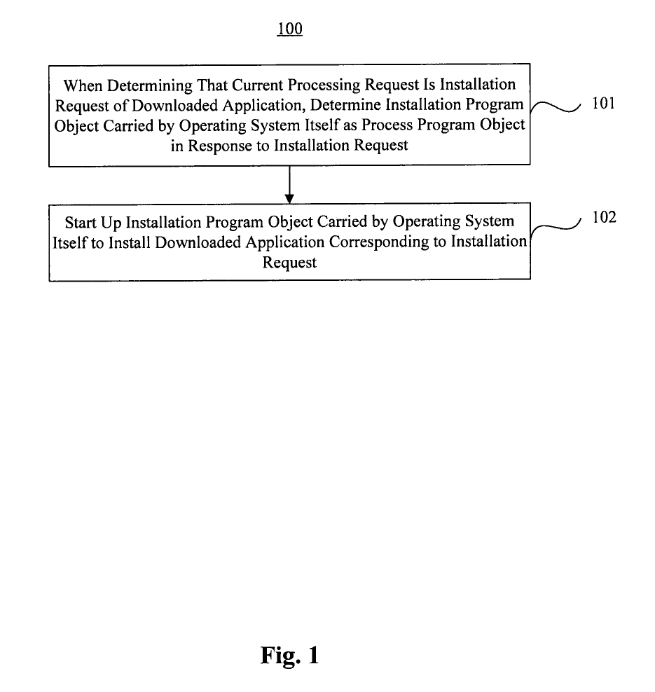

FIG. 1 is a flowchart of a method 100 for installing an application on a device, according to an exemplary embodiment. Referring to FIG. 1, the method 100 includes the following steps.

In step 101, when determining that a current processing request is an installation request of a downloaded application, the device determines an installation program object carried by an operating system itself as a process program object in response to the installation request.

In step 102, the device starts up the installation program object carried by the operating system itself to install the downloaded application corresponding to the installation request.

In the present embodiment, when determining that the current processing request is an installation request of a downloaded application, the device mandatorily selects the installation program object carried by the operating system itself to install the application corresponding to the current processing request, which prevents a malicious application from participating in the process of application installation, thus improving security of the operating system.

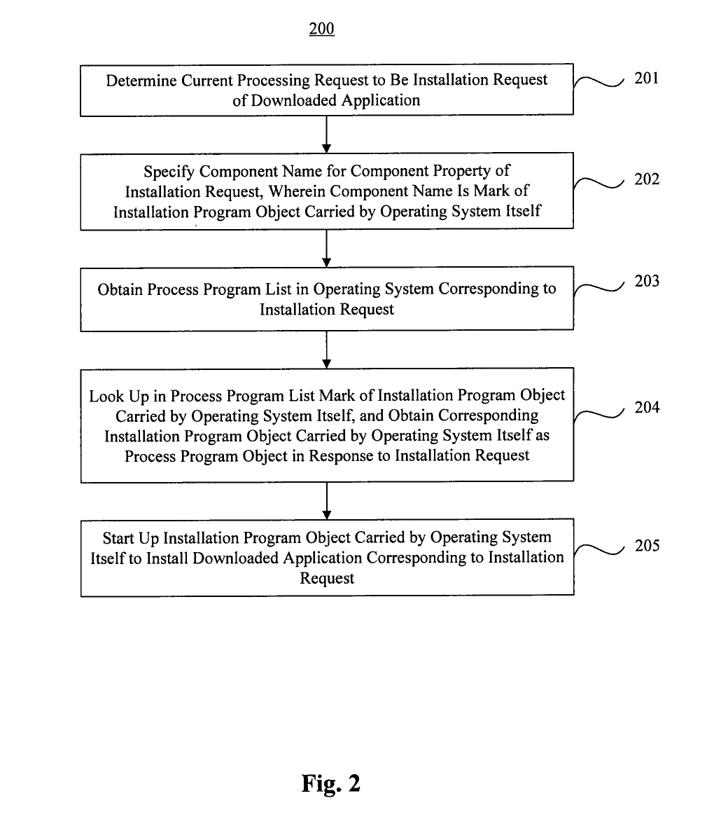

FIG. 2 is a flowchart of a method 200 for installing an application on a device, according to an exemplary embodiment. In the present embodiment, the device operates on an Android operating system, but the method 200 is not limited to the Android operating system, and is also applicable to other operating systems. Referring to FIG. 2, the method 200 includes the following steps.

In step 201, the device determines a current processing request to be an installation request of a downloaded application.

For example, there are many applications for use in the Android operating system, and each application may send various requests in an interactive process with the operating system or other applications, such as an interface starting up request, a networking request, and the like. The device identifies the installation request of the downloaded application from various requests. In one exemplary embodiment, the determining of the current process request to be the installation request of the downloaded application may include the following sub-steps.

In a first sub-step, the device obtains property information of the current processing request, wherein the property information includes an action property and a type property.

For example, when an application sends a request, the request includes the application's intent. The Android operating system selects proper components according to content of the intent to complete the request. The intent is a run-time binding mechanism, which can connect two different components in an operation process of the application. An intent object is configured to describe the operation to be executed, and the basic content described may be divided into six portions including a component name, an action, data, a category, extra information, and a flag.

The component name in the intent object is a component property, and is the name of a target component of the intent. The component name is a ComponentName object. This object is a combination of a category name of the target component and a package name of the application where the target component is located. The package name where the target component is located does not necessarily match the package name in a manifest document exactly. The component name is an option. If an intent message indicates the name of the target component, the intent message is an explicit message, so that the intent is transmitted to the indicated component. If the name of the target component is not indicated, the Android operating system may select a proper target component by comparing other information in the intent with a registered IntentFilter.

The action in the intent object depicts a character string of a name of the action triggered by the intent. Theoretically, the action may be any character string. Action character strings related to applications of the Android operating system are defined in an intent category in a form of static state character string constant.

The data in the intent object depicts a uniform resource identifier (URI) and a type of the data to be operated by the intent. For example, certain actions need to process corresponding data.

The category in the intent object is additional depiction information for the requested component.

In the present embodiment, the property information of the current processing request is the content of the intent, and the current processing request may be interpreted by using a chooseBestActivity method provided in the Android operating system, so that the property information of the current processing request is obtained. The chooseBestActivity method is a method in a category of package manager service provided in the Android operating system, called com.android.server.pm.PackageManagerService (PMS). The PMS calls the chooseBestActivity method to select an optimal activity object matching the intent. In the Android operating system, after downloading an application, a downloaded installation package is stored in the PMS, and the PMS is responsible for installing, uninstalling, and managing various applications and the like. The PMS is started up by a systemServer at boot time. At boot time, the PMS interprets data related to previously stored installation packages. A newly installed Android application package (APK) file in the operation process of the Android operating system may also be stored in a related variable of the PMS, or may be written into a related document to be permanently stored.

In a second sub-step, if the action property and the type property are respectively consistent with the action property and the type property is preset for the installation request of the downloaded application, the device determines the current processing request to be the installation request of the downloaded application.

In the present embodiment, if the action property (action) and the category property (type) of the current processing request have values consistent with those of the preset action property and the preset type property for the installation request, the current processing request is determined to be the installation request of the downloaded application.

In step 202, the device specifies a component name for a component property of the installation request, the component name being a mark of the installation program object carried by the operating system itself.

In the present embodiment, when identifying the current processing request to be the installation request of the downloaded application, the device specifies the component name of the target component for the component property (component) of the installation request. The component name is the mark of the installation program object carried by the operating system itself, which is to set ComponentName in the intent object to be the mark of the installation program object carried by the operating system itself, so that the process program object indicated by the installation request is the installation program object carried by the operating system itself.

In exemplary embodiments, the installation program object carried by the operating system itself is a default installation program of the operating system. The installation program is an application program to assist the user in installing another application or a driving program.

In step 203, the device obtains a process program list in the operating system corresponding to the installation request.

For example, the Android operating system stores a process program list that stores one or more process program objects having installation ability. Each process program object may be an installation program object carried by the operating system itself, or a third-party installation program object. When a process program object having installation ability submits an application for registration to the operating system, if the operating system determines that the process program object has installation ability according to the application for registration, the operating system accepts the application for registration of the process program object, and adds the process program object into the process program list.

In step 204, the device looks up in the process program list the mark of the installation program object carried by the operating system itself, and obtains the installation program object carried by the operating system itself as a process program object in response to the installation request.

In the present embodiment, the ComponentName in the intent object of the installation request of the downloaded application is the mark of the installation program object carried by the operating system itself, namely, the target component name is indicated in the intent message. Accordingly, in the process of matching with the one or more process program objects in the process program list, the intent may be directly matched to the indicated component (the indicated component in the present embodiment refers to the installation program object carried by the operating system itself), and the intent is directly transmitted to the indicated component.

In step 205, the device starts up the installation program object carried by the operating system itself to install the downloaded application corresponding to the installation request.

For example, when the installation program object carried by the operating system itself, which the intent of the installation request of the downloaded application matches, is a target component, the installation program object carried by the operating system itself obtains an installation package corresponding to the installation request from the PMS to install the application.

In the method 200, by directly starting up the installation program object carried by the operating system itself to install the application indicated by the corresponding installation request, other than starting up a selection dialog box including a plurality of process programs for the user to select, a purpose of shielding malicious applications is achieved, so as to prevent the harm caused by the user's incorrect choice of the process program object, and to protect the user.

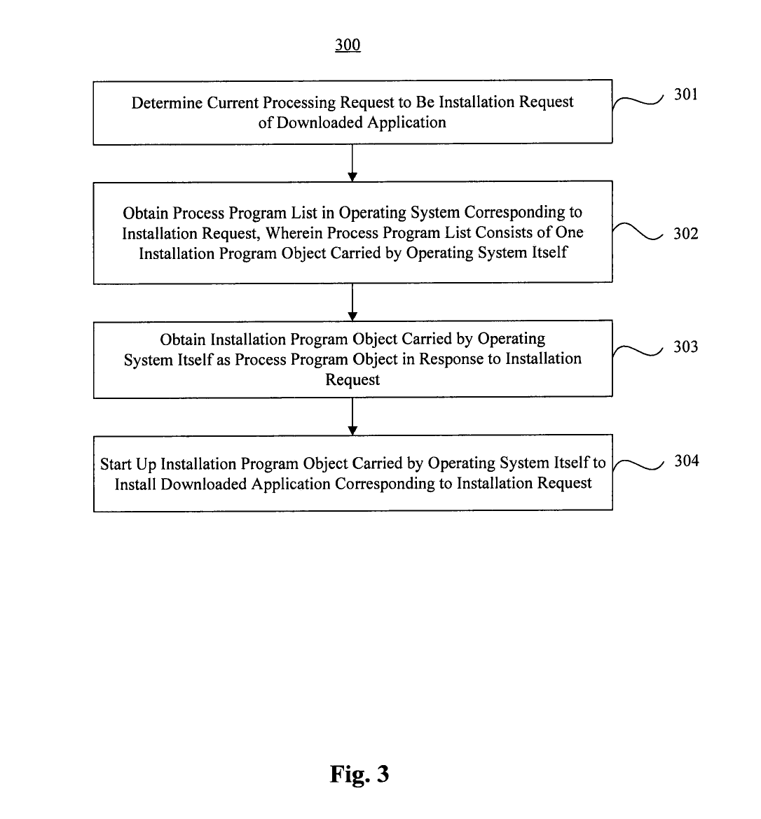

FIG. 3 is a flowchart of a method 300 for installing an application on a device, according to an exemplary embodiment. In the present embodiment, the device operates on the Android operating system, but the method 300 is not limited to the Android operating system, and is also applicable to other operating systems. Referring to FIG. 3, the method 300 includes the following steps.

In step 301, the device determines a current processing request to be an installation request of a downloaded application.

In one exemplary embodiment, step 301 may include the following sub-steps.

In a first sub-step, the device obtains property information of the current processing request, wherein the property information includes an action property and a type property.

In a second sub-step, if the action property and the type property are respectively consistent with the action property and the type property preset for the installation request of the downloaded application, the device determines the current processing request to be the installation request of the downloaded application.

In step 302, the device obtains a process program list in the operating system corresponding to the installation request, wherein the process program list includes one installation program objects carried by the operating system itself.

For example, the Android operating system stores a process program list that stores one or more process program objects having installation ability. Theoretically, a process program object may be an installation program object carried by the operating system itself, or may be a third-party installation program object. However, in the present embodiment, the Android operating system, when receiving an application for registration of the third-party installation program object, refuses the application. Accordingly, the Android operating system in the present embodiment ignores registration of the third-party installation program object, and only accepts registration of the installation program object carried by the operating system itself. Thus, the process program list only includes therein the installation program object carried by the operating system itself. Generally, an operating system carries one installation program object. Therefore, the device is forced to select the installation program object carried by the operating system itself.

In step 303, the device obtains the installation program object carried by the operating system itself as a process program object in response to the installation request.

In step 304, the device starts up the installation program object carried by the operating system itself to install the downloaded application corresponding to the installation request.

In the method 300, when receiving a request for registration, except for the request for registration from the installation program object of the operating system, the device ignores all of other requests for registration from third-party process program objects, so that the process program list only includes one installation program object carried by the operating system itself, thereby achieving the purposes of shielding the third-party process program objects, and preventing the third-party process program objects or malicious applications from intercepting the user's installation of the downloaded application.

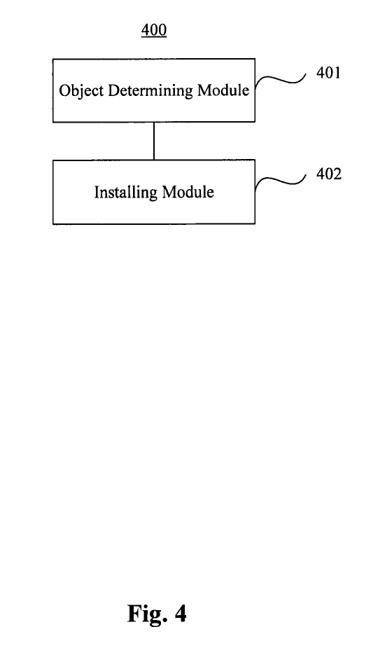

FIG. 4 is a block diagram of a device 400 for installing an application, according to an exemplary embodiment. Referring to FIG. 4, the device 400 includes an object determining module 401 configured to, when determining that a current processing request is an installation request of a downloaded application, determine an installation program object carried by an operating system itself as a process program object in response to the installation request, and an installing module 402 configured to start up the installation program object carried by the operating system itself to install the downloaded application corresponding to the installation request.

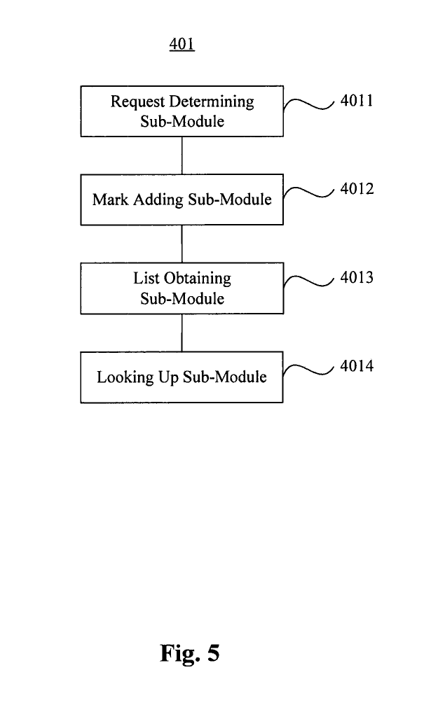

FIG. 5 is a block diagram of the object determining module 401 (FIG. 4), according to an exemplary embodiment. Referring to FIG. 5, the object determining module 401 includes a request determining sub-module 4011 configured to determine a current processing request as an installation request of a downloaded application, and a mark adding sub-module 4012 configured to specify a component name for a component property of the installation request, wherein the component name is a mark of the installation program object carried by the operating system itself. The object determining module 401 also includes a list obtaining sub-module 4013 configured to obtain a process program list in the operating system corresponding to the installation request, and a looking up sub-module 4014 configured to look up in the process program list the mark of the installation program object carried by the operating system itself, and obtain the corresponding installation program object carried by the operating system itself as a process program object in response to the installation request.

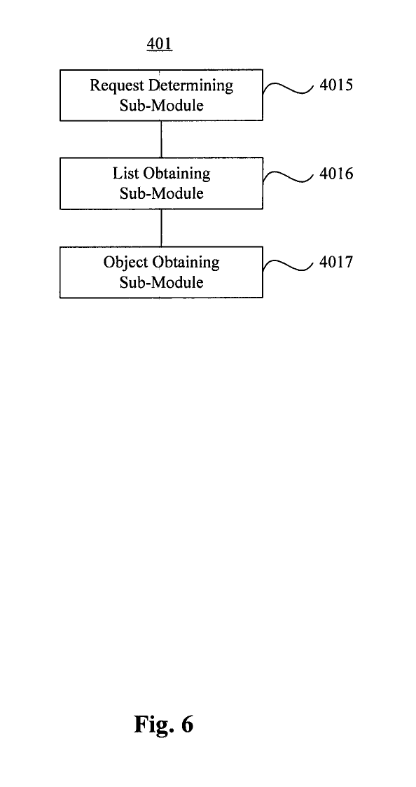

FIG. 6 is a block diagram of the object determining module 401 (FIG. 4), according to an exemplary embodiment. Referring to FIG. 6, the object determining module 401 includes a request determining sub-module 4015 configured to determine a current processing request as an installation request of a downloaded application, and a list obtaining sub-module 4016 configured to obtain a process program list in the operating system corresponding to the installation request, wherein the process program list includes one installation program object carried by the operating system itself. The object determining module 401 also includes an object obtaining sub-module 4017 configured to obtain the installation program object carried by the operating system itself as a process program object in response to the installation request.

In one exemplary embodiment, the request determining sub-module 4011 (FIG. 5) or 4015 (FIG. 6) includes a property information obtaining unit configured to obtain a property information of the current processing request, wherein the property information includes an action property and a type property.

In one exemplary embodiment, a chooseBestActivity method provided in the Android operating system may be applied to obtain the property information of the current processing request.

In one exemplary embodiment, the request determining sub-module 4011 (FIG. 5) or 4015 (FIG. 6) also includes a determining unit configured to determine the current processing request to be the installation request of the downloaded application, when the action property and the type property are respectively consistent with the action property and the type property preset for the installation request of the downloaded application.

In exemplary embodiments, there is also provided a non-transitory readable storage medium including instructions for a processor to perform the above-described methods for installing an application.

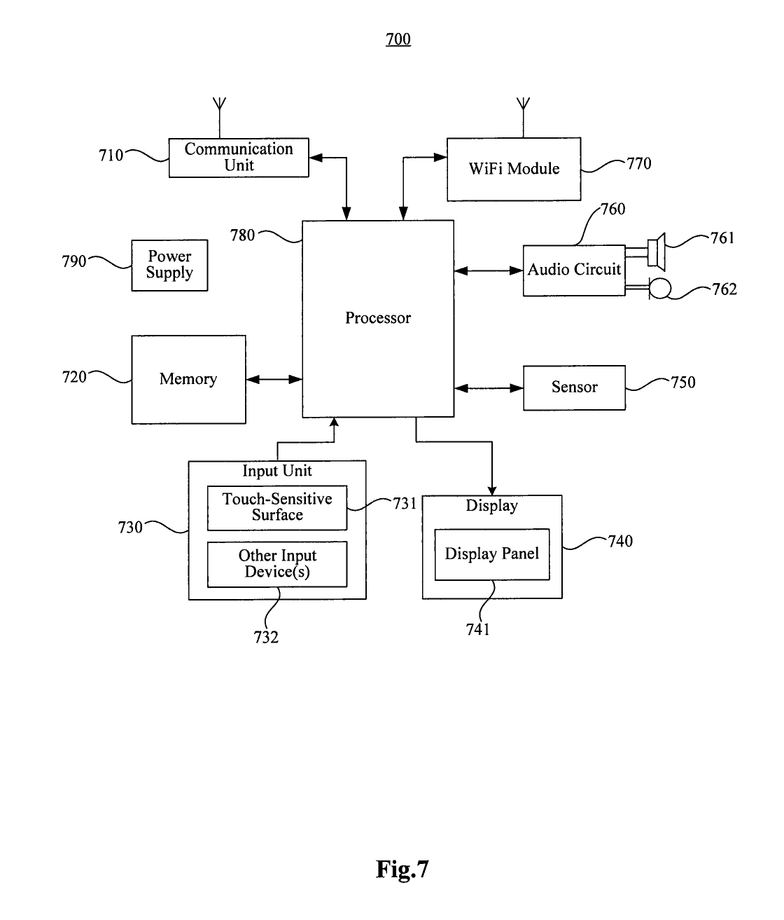

FIG. 7 is a block diagram of a device 700, according to an exemplary embodiment. For example, the device 700 is configured to implement the above described methods for installing an application. The device 700 may be a mobile phone, a tablet computer, a wearable device such as a smart watch, or the like.

Referring to FIG. 7, the device 700 may include one or more of a communication unit 710, memory resources represented by a memory 720, an input unit 730, a display 740, a sensor 750, an audio circuit 760, a wireless fidelity (WiFi) module 770, a processor 780 including one or more processing cores, a power supply 790 and the like. Those skilled in the art will understand that, the structure shown in FIG. 7 is not restrictive to the device 700, and the device 700 may include more or less components than those shown in FIG. 7, or a combination of certain components, or have different component arrangements.

The communication unit 710 is configured to send and receive signals during sending and receiving of information or a process of calling. The communication unit 710 may be a network communication device such as a radio frequency (RF) circuit, a router, a modem or the like. When the communication unit 710 is an RF circuit, the communication unit 710 may receive downlink information of a base station, and transmit the downlink information to the processor 780 to process. In addition, the communication unit 710 may transmit related uplink data to the base station. Usually, the RF circuit as the communication unit 710 includes, but is not limited to, an antenna, at least one amplifier, a tuner, one or more oscillator, a subscriber identity module (SIM) card, a transceiver, a coupler, a low noise amplifier (LNA), a diplexer and the like. In addition, the communication unit 710 may also communicate with a network and other devices through wireless communication. The wireless communication may apply any one of the communication standards or protocols, which include but are not limited to global system of mobile communication (GSM), general packet radio service (GPRS), code division multiple access (CDMA), wideband code division multiple access (WCDMA), long term evolution (LTE), E-mail, short messaging service (SMS), or the like.

The memory 720 is configured to store software programs and modules, and the processor 780 executes various function applications and data processing through executing software programs and modules stored in the memory 720. The memory 720 may mainly include a program storage area and a data storage area. The program storage area may store an operating system, application programs required by at least one function (for example, a sound playing function, an image playing function, and the like), etc. The data storage area may store data created according to the applications of the device 700 (for example, audio data, phone books and the like), etc. In addition, the memory 720 may include a high-speed random access memory, and may also include a nonvolatile storage, such as at least one disk storage, a flash storage, or other non-volatile solid-state memories. Correspondingly, the memory 720 may also include a memory controller to provide accessing of the processor 780 and the input unit 730 to the memory 720.

The input unit 730 is configured to receive input digital or character information, and generate signal input from a keyboard, a mouse, a joystick, an optical device, or a trackball related to the user setting and function control. The input unit 730 may include a touch-sensitive surface 731 and one or more other input devices 732. The touch-sensitive surface 731, also called a touch screen or a touchpad, may collect the user's touch operation thereon or nearby (for example, the user's operation on or near the touch-sensitive surface 731 by using any suitable object or accessory such as a finger, a touch pen, or the like), and drive a corresponding connected device according to pre-set programs. The touch-sensitive surface 731 may include first and second portions, i.e., a touch detect device and a touch controller. The touch detect device detects the user's touch operation, and detects the signal caused by the touch operation, sends the signal to the touch controller. The touch controller receives touch information from the touch detect device, converts it into contact point coordinates, and then sends the contact point coordinates to the processor 780. The touch controller can receive instructions sent by the processor 780 so as to execute them. In addition, the touch-sensitive surface 731 may be realized in various types, such as a resistive type, a capacitive type, an infrared type, or a surface acoustic wave type, and the like. In addition, the input unit 730 may also include one or more other input devices 732. The other input devices 732 may include but are not limited to one or more devices such as a physical keyboard, function keys (for example, volume control keys, switch keys and the like), a trackball, a mouse, and a joystick.

The display 740 is configured to display information input by the user or information provided to the user and various user image interfaces. The user image interfaces may consist of images, texts, icons, videos and arbitrary combinations thereof. The display 740 may include a display panel 741 configured by using a liquid crystal display (LCD), an organic light-emitting diode (OLED), and the like. Further, the touch-sensitive surface 731 may cover the display panel 741. The touch-sensitive surface 731, when detecting a touch operation thereon or nearby, transmits the touch operation to the processor 780 to determine a type of the touch operation, and then the processor 780 provides a corresponding visual output on the display panel 741 according to the type of the touch operation. Although in FIG. 7 the touch-sensitive surface 731 and the display panel 741 may be two separated parts to implement input and input functions, in some embodiments, the touch-sensitive surface 731 and the display panel 741 maybe integrated to implement the input and the output functions.

The sensor 750 may be an optical sensor, a motion sensor, or any other sensors. The optical sensor may include an environment optical sensor and an approaching sensor. The environment optical sensor may adjust a brightness of the display panel 741 according to the brightness of the environment light, and the approaching sensor may turn off the display panel 741 and/or the backlight when the device 700 moves to near the user's ear. As an example of the motion sensor, a gravity acceleration sensor may detect magnitudes of acceleration on respective directions (e.g., along three axes), may detect values and directions of the gravity when in stationary state, and may be configured to recognize applications of the device attitude (for example, horizontal and vertical screen switching, related games, magnetometer gesture calibration), vibration recognize related functions (for example a pedometer, knocking) and the like. The device 700 may also be configured with other sensors such as a gyro, a barometer, a hygrometer, a thermometer, an infrared sensor and the like.

The audio circuit 760 is coupled to a loudspeaker 761 and a microphone 762, and may provide an audio interface between the user and the device 700. The audio circuit 760 may transmit an electrical signal converted from received audio data to the loudspeaker 761 to be converted into a sound signal output. On the other hand, the microphone 762 converts collected sound signals into electrical signals, and the audio circuit 760 receives the electrical signals and then converts them into audio data. The audio data is output to the processor 780 to be processed, and is then transmitted to another device thought the communication unit 710, or is output to the memory 720 to be further processed. The audio circuit 760 may also include an ear jack to provide communication between an external earphone and the device 700.

The WiFi module 770 provides wireless broadband internet access, which allows the user to transmit or receive E-mail, browse web pages, and access streaming media and the like. Although the WiFi module 770 is shown in FIG. 7, it should be understood that the WiFi module 770 is not a necessary component of the device 700, and may be omitted according to requirements.

The processor 780 is a control center of the device 700 using various interfaces and wires to connect respective components of the device 700. By operating or executing software programs and/or modules stored in the memory 720, invoking data stored in the memory 720, and executing various functions of the device 700 and processing data, the processor 780 handles overall monitoring to the device 700. The processor 780 may include one or more processing cores, and may integrate an application processor and a modem processor. The application processor mainly processes the operating system, user interfaces, application programs and the like, and the modem processor mainly processes wireless communications. In some embodiments, the modem processor may be not integrated into the processor 780.

The power supply 790 is configured to supply power to respective components of the device 700. The power supply 790 may be logically connected with the processor 780 through a power supply management system, thereby realizing functions of managing charging or discharging through the power supply management system, and managing the power consuming and the like. The power supply 790 may also include one or more of a direct current (DC) power supply or an alternating current (AC) power supply, a rechargeable system, a power supply malfunction detecting circuit, a power supply converter or an inverter, a power supply state indicator and the like.

Although not shown, the device 700 may also include a camera, a Bluetooth module or the like.

In exemplary embodiments, there is also provided a non-transitory readable storage medium including instructions, such as included in the memory 720, executable by the processor 780 in the device 700, for performing the above-described methods for installing an application. For example, the computer-readable storage medium may be a magnetic disc memory, a CD-ROM, an optical memory and the like.

One of ordinary skill in the art will understand that the above described modules can each be implemented by hardware, or software, a combination of hardware and software. One of ordinary skill in the art will also understand that multiple ones of the above described modules may be combined as one module, and each of the above described modules may be further divided into a plurality of sub-modules.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for installing an application on a device, comprising:
when determining that a current processing request is an installation request of a downloaded application, determining an installation program object carried by an operating system itself as a process program object in response to the installation request; and
starting up the installation program object carried by the operating system itself to install the downloaded application corresponding to the installation request.

2. The method according to claim 1, wherein the determining of the installation program object carried by the operating system itself as the process program object in response to the installation request comprises:
specifying a component name for a component property of the installation request, wherein the component name is a mark of the installation program object carried by the operating system itself;
obtaining a process program list in the operating system corresponding to the installation request; and
looking up in the process program list the mark of the installation program object carried by the operating system itself, and obtaining the corresponding installation program object carried by the operating system itself as the process program object in response to the installation request.

3. The method according to claim 1, wherein the determining of the installation program object carried by the operating system itself as the process program object in response to the installation request comprises:
obtaining a process program list in the operating system corresponding to the installation request, the process program list including one installation program object carried by the operating system itself; and
obtaining the one installation program object carried by the operating system itself as the process program object in response to the installation request.

4. The method according to claim 1, wherein the determining that the current process request is the installation request of the downloaded application comprises:
obtaining property information of the current processing request, wherein the property information includes an action property and a type property; and
if the action property and the type property are respectively consistent with an action property and a type property preset for the installation request of the downloaded application, determining the current processing request to be the installation request of the downloaded application.

5. The method according to claim 4, wherein the obtaining of the property information of the current processing request comprises:
applying a chooseBestActivity method to obtain the property information of the current process request.

6. A device for installing an application, comprising:
a processor; and
a memory for storing instructions executable by the processor;
wherein the processor is configured to:
when determining that a current processing request is an installation request of a downloaded application, determine an installation program object carried by an operating system itself as a process program object in response to the installation request; and
start up the installation program object carried by the operating system itself to install the downloaded application corresponding to the installation request.

7. The device according to claim 6, wherein the processor is further configured to:
determine the current processing request to be the installation request of the downloaded application;
specify a component name for a component property of the installation request, wherein the component name is a mark of the installation program object carried by the operating system itself;
obtain a process program list in the operating system corresponding to the installation request; and
look up in the process program list the mark of the installation program object carried by the operating system itself, and obtain the corresponding installation program object carried by the operating system itself as the process program object in response to the installation request.

8. The device according to claim 6, wherein the processor is further configured to:
determine the current process request to be the installation request of the downloaded application;
obtain a process program list in the operating system corresponding to the installation request, the process program list including one installation program object carried by the operating system itself; and
obtain the one installation program object carried by the operating system itself as the process program object in response to the installation request.

9. The device according to claim 7, wherein the processor is further configured to:
obtain property information of the current processing request, wherein the property information includes an action property and a type property; and
determining the current processing request to be the installation request of the downloaded application, when the action property and the type property are respectively consistent with an action property and a type property preset for the installation request of the downloaded application.

10. The device according to claim 8, wherein the processor is further configured to:
obtain property information of the current processing request, wherein the property information includes an action property and a type property; and
determining the current processing request to be the installation request of the downloaded application, when the action property and the type property are respectively consistent with an action property and a type property preset for the installation request of the downloaded application.

11. The device according to claim 9, wherein the processor is further configured to:
apply a chooseBestActivity method to obtain the property information of the current process request.

12. A non-transitory storage medium having stored therein instructions that, when executed by a processor of a device, cause the device to perform a method for installing an application, the method comprising:
when determining that a current processing request is an installation request of a downloaded application, determining an installation program object carried by an operating system itself as a process program object in response to the installation request; and
starting up the installation program object carried by the operating system itself to install the downloaded application corresponding to the installation request.
